(19) United States
(12) Patent Application Publication
(10) Pub. No.: US 2011/0203281 A1
(43) Pub. Date: Aug. 25, 2011

(54) ARTICLE FOR HIGH TEMPERATURE SERVICE

(75) Inventors: Reza Sarrafi-Nour, Clifton Park, NY (US); Peter Joel Meschter, Niskayuna, NY (US); Curtis Alan Johnson, Niskayuna, NY (US); Krishan Lal Luthra, Niskayuna, NY (US)

(73) Assignee: GENERAL ELECTRIC COMPANY, Schenectady, NY (US)

(21) Appl. No.: 12/712,262

(22) Filed: Feb. 25, 2010

(51) Int. Cl. F23R 3/42; B32B 9/04; F01D 9/02; F01D 5/28

(52) U.S. Cl. 60/722; 428/446; 428/448; 415/200; 416/241 R

(57) ABSTRACT

An article comprises a substrate and a coating disposed over the substrate, wherein the coating comprises a monoclinic silicate phase that undergoes no solid state phase transformation reaction in the temperature range from about 1100 degrees Celsius to about 1275 degrees Celsius. Another article comprises a substrate comprising a silicon-bearing ceramic material; a bondcoat disposed over the substrate, wherein the bondcoat comprises silicon; a coating disposed over the bondcoat, wherein the coating comprises a monoclinic silicate phase, the silicate phase comprising a) yttrium and b) at least one other species selected from the group consisting of ytterbium and lutetium, wherein the material undergoes no solid state phase transformation reaction in the temperature range from about 1100 degrees Celsius to about 1275 degrees Celsius; and a topcoat disposed over the coating, wherein the topcoat comprises at least one selected from the group consisting of an aluminate, an aluminosilicate, a silicate (such as a rare earth monosilicate, for example), and zirconia.

### STATEMENT REGARDING FEDERALLY SPONSORED RESEARCH AND DEVELOPMENT

This invention was made with Government support under contract number DE-FC26-05NT42643, awarded by the U.S. Department of Energy. The Government has certain rights in the invention.

### BACKGROUND

This invention relates to high-temperature machine components. More particularly, this invention relates to coating systems for protecting machine components from exposure to high-temperature environments.

High-temperature materials, such as, for example, ceramics, alloys, and intermetallics, offer attractive properties for use in structures designed for service at high temperatures in such applications as gas turbine engines, heat exchangers, and internal combustion engines, for example. However, the environments characteristic of these applications often contain reactive species, such as water vapor, which at high temperatures may cause significant degradation of the material structure. For example, water vapor has been shown to cause significant surface recession and mass loss in silicon-bearing materials. The water vapor reacts with the structural material at high temperatures to form volatile silicon-containing species, often resulting in unacceptably high recession rates.

Environmental barrier coatings (EBC's) are applied to silicon-bearing materials and other material susceptible to attack by reactive species, such as high temperature water vapor; EBC's provide protection by prohibiting contact between the environment and the surface of the material. EBC's applied to silicon-bearing materials, for example, are designed to be relatively stable chemically in high-temperature, water vapor-containing environments. One exemplary conventional EBC system, as described in U.S. Pat. No. 6,410,148, comprises a silicon or silica bond layer (also referred to herein as a “bondcoat”) applied to a silicon-bearing substrate; an intermediate layer comprising mullite or a mullite-alkaline earth aluminosilicate mixture deposited over the bond layer; and a top layer comprising an alkaline earth aluminosilicate deposited over the intermediate layer. In another example, U.S. Pat. No. 6,296,941, the top layer is a yttrium silicate layer rather than an aluminosilicate.

The above coating systems can provide suitable protection for articles in demanding environments, but opportunities for improvement in coating performance exist. For instance, yttrium silicate materials, such as yttrium disilicate and yttrium monosilicate, may be prone to cracking during high temperature service.

Therefore, there remains a need in the art for environmental barrier coatings with improved durability at high temperatures. There is also a need for machine components employing these coating systems to enhance high-temperature service capability.

### BRIEF DESCRIPTION

Embodiments of the present invention are provided to meet these and other needs. One embodiment is an article. The article comprises a substrate and a coating disposed over the substrate, wherein the coating comprises a monoclinic silicate phase, wherein the phase undergoes no solid state phase transformation reaction in the temperature range from about 1100 degrees Celsius to about 1275 degrees Celsius.

Another embodiment is an article. The article comprises a substrate comprising a silicon-bearing ceramic material; a bondcoat disposed over the substrate, wherein the bondcoat comprises silicon; a coating disposed over the bondcoat, wherein the coating comprises a monoclinic silicate phase, the silicate phase comprising a) yttrium and b) at least one other species selected from the group consisting of ytterbium and lutetium, wherein the material undergoes no solid state phase transformation reaction in the temperature range from about 1100 degrees Celsius to about 1275 degrees Celsius; and a topcoat disposed over the coating, wherein the topcoat comprises at least one selected from the group consisting of an aluminate, an aluminosilicate, a silicate (such as a rare earth monosilicate, for example), and zirconia, such as yttria-stabilized zirconia.

### DETAILED DESCRIPTION

According to one embodiment of the present invention, an article for use at high temperature comprises a substrate and a coating disposed over the substrate. Examples of such an article include, for example, a component of a gas turbine assembly, such as, but not limited to, a blade, vane, shroud, or combustor component, such as a combustor liner. Because the efficiency of a gas turbine generally increases as a function of the firing temperature, having components capable of operation at increased temperatures may offer benefits leading to enhanced fuel economy and reduced emissions. Moreover, increasing the service life of the EBC system may improve cost-effectiveness by, for example, increasing the intervals between major service events.

The coating may be part of a multilayered EBC system designed to protect the substrate from high-temperature environments. In one embodiment, a bondcoat is disposed between the substrate and the coating, either immediately between or with one or more intervening intermediate layers. The bondcoat typically comprises silicon; examples of bondcoat materials include elemental silicon, silicon oxide, and silicide compounds. The bondcoat inhibits deleterious oxidation reactions from occurring at the substrate/coating interface.

In a further embodiment, a topcoat may be disposed over the coating, either directly adjacent or with one or more intervening intermediate layers. In some embodiments, the function of the topcoat is to provide a recession-resistant barrier to water vapor at high temperatures. Accordingly, any material that provides such a barrier may be suitable for use as a topcoat. In certain embodiments, the topcoat comprises an aluminate, a silicate, an aluminosilicate, or some combination including one or more of these; such compounds are known in the art for their effectiveness as recession resistant coatings. As used herein, the term “silicate” shall be understood to include monosilicates, disilicates, orthosilicates, and other compounds of the silicate family. Examples of topcoat compositions include aluminates, silicates, and aluminosilicates of alkaline earth elements, yttrium, scandium, or the rare earth elements. Specific examples include barium strontium aluminosilicate, yttrium silicates, and monosilicates of rare earth elements. In alternative embodiments, the function of the topcoat is to provide thermal protection for the substrate. Ceramic thermal barrier coatings (TBC's) are well known in the art for use in high temperature protection of engineered components. Zirconia, such as yttria-stabilized zirconia, is a prominent example of coatings of this type, and is suitable for use as the topcoat in some embodiments of the present invention. Finally, in some embodiments, an outer layer of TBC is disposed over a topcoat of one or more of the recession resistant coatings described above.

The coating of the present invention comprises a monoclinic silicate phase. The composition of the monoclinic silicate phase is engineered to be phase stable within a selected temperature range, such as a temperature range of interest to the applications described above. “Phase stable,” as used herein, means that the phase undergoes no solid-state phase transformation reaction over the specified temperature range. Certain silicate phases, such as, but not limited to, yttrium disilicate, though having otherwise attractive properties, are susceptible to undesirable grain growth and cracking over prolonged exposure to temperatures exceeding 1000 degrees. Further, the present inventors have determined that these undesirable effects may arise from a phase transformation between two monoclinic crystal structures, known in the art as beta (or type-C) and gamma (or type-D) disilicate. Without being bound by theory, it is speculated that the change in volume associated with the phase transformation creates stresses that may lead to cracking; in the case of coatings, this cracking can lead to spallation of the coating. In fact, the problems noted above may be more pronounced in coatings relative to bulk materials, because many coating processes, such as chemical vapor deposition (CVD), physical vapor deposition (PVD), and thermal spray techniques often tend to produce coating structures with grains having preferred orientation and crystallographic texturing. To overcome these problems, embodiments of the present invention include compositions that stabilize one phase, such as stabilizing the beta phase or stabilizing the gamma phase, thereby altering the behavior of the material to prevent the phase transformation from occurring within a temperature range of interest. In one embodiment, the temperature range over which no transformation occurs is from about 1100 degrees Celsius to an upper temperature of about 1275 degrees Celsius. In certain embodiments, the upper temperature is about 1300 degrees Celsius, and in particular embodiments the upper temperature is about 1550 degrees Celsius. It will be appreciated that the definition of the temperature range above does not imply anything about the phase stability of the material outside the stated temperature range; the material may be phase stable outside the stated range, or it may not be, but in any case it is phase stable at temperatures within the stated range.

In one embodiment, the silicate phase is present in the coating at a level of at least about 50% by volume. In certain embodiments, this level is at least about 80% by volume, and in particular embodiments this level is at least about 90% by volume.

In some embodiments, the silicate phase has a composition in accordance with the following formula:

A₂₍₁₋ₓ₎D₂ₓSi₂O₇, (also referred to herein as “formula (I)”)

where x is in the range from about 0.01 to about 0.9.

In the above formula, the species occupying the A sites in the crystal lattice structure of the phase (which species is simply referred to herein as “A”) is at least one element selected from the group consisting of erbium, yttrium, holmium, dysprosium, terbium, and gadolinium. The species D may substitute for A in the lattice, or may occupy its own unique site in the lattice.

In embodiments of the present invention, the addition of species D to the silicate composition serves to stabilize a monoclinic phase. In one embodiment, the monoclinic phase that is stabilized is the beta phase, and in other embodiments, the monoclinic phase that is stabilized is the gamma phase. In accordance with relationships determined by Felsche among (1) the ionic radius of a given cation, (2) the crystal structure of the silicate phase of interest, and (3) the stability temperature range of the particular silicate phase, the desired phase may be stabilized by doping a conventional disilicate of species A with species D, where the ionic radius of D has a specific relationship to the ionic radius of A. In the above formula, D is at least one cation having an ionic radius smaller than the ionic radius of A. Examples of elements that may be suitable for use as species D include scandium, lutetium, ytterbium, thulium, titanium, and zirconium. These elements have cations that may exhibit the same six-fold coordination in the crystal lattice as the species A does; moreover, the scandium, lutetium, ytterbium, thulium, and titanium can be trivalent, as is species A; having the same valence as species A maintains charge neutrality when substituting a cation for species A. Also, zirconium and titanium have quadrivalent cations, which may require some charge compensation to maintain neutrality when substituted for species A. When the proper amount of dopant (D) is added to the silicate phase, the mean ionic radius of the cation in the lattice is moved towards values that promote stability of monoclinic phase per the Felsche relationship.

In one embodiment, A includes yttrium. In certain embodiments, A includes yttrium and D includes ytterbium. The ytterbium, in some embodiments, is present in the composition at levels for x (from the above formula) in the range from about 0.05 to about 0.5. In particular embodiments, x is in the range from about 0.2 to about 0.4. One particular example of a suitable composition is one in which A includes yttrium, D includes ytterbium, and x is 0.4. In another example, A includes yttrium, and D includes scandium. The scandium, in some embodiments, is present in the composition at levels for x in the range from about 0.05 to about 0.2. In still another example, A includes yttrium and D includes lutetium. The lutetium, in some embodiments, is present in the composition at levels for x in the range from about 0.05 to about 0.35. One particular example of a suitable composition is one in which A includes yttrium, D includes ytterbium, and x is 0.35.

The bondcoat, topcoat, and coating described herein may be applied by any of several methods used to deposit coatings, including chemical vapor deposition (CVD), physical vapor deposition (PVD), and thermal spray techniques, all of which are well known in the coating arts. The thickness of the various layers is comparable to that used in other EBC systems. For instance, in some embodiments the bondcoat has a thickness of up to about 250 micrometers. In certain embodiments, this thickness is in the range from about 50 micrometers to about 150 micrometers, and in particular embodiments the thickness is in the range from about 80 micrometers to about 120 micrometers. The thickness of the topcoat is comparable to that used in other EBC systems, and is generally selected to provide adequate protection for the particular environment and desired service life of the substrate being coated. In certain embodiments, the topcoat has a thickness of greater than about 25 micrometers. In particular embodiments, the thickness is in the range from about 125 micrometers to about 500 micrometers. The thickness of the coating of the present invention, in certain embodiments, is comparable to the ranges given above for the topcoat.

The substrate comprises silicon in some embodiments. The substrate may comprise a silicon-bearing ceramic compound, metal alloy, intermetallic compound, or combinations of these. Examples of intermetallic compounds include, but are not limited to, niobium silicide and molybdenum silicide. Examples of suitable ceramic compounds include, but are not limited to, silicon carbide, molybdenum disilicide, and silicon nitride. Embodiments of the present invention include those in which the substrate comprises a ceramic matrix composite (CMC) material. CMC's typically comprise a matrix phase and a reinforcement phase embedded in the matrix phase. The CMC may be any material of this type, including composites in which the CMC matrix phase and reinforcement phase both comprise silicon carbide. Regardless of material composition, in some embodiments the substrate comprises a component of a turbine assembly, such as, among other components, a combustor component, a shroud, a turbine blade, or a turbine vane.

In a particular embodiment, an article for high temperature service, such as a component of a gas turbine assembly, comprises a substrate comprising a silicon-bearing ceramic material; a bondcoat disposed over the substrate, wherein the bondcoat comprises silicon; a coating disposed over the bondcoat, wherein the coating comprises a monoclinic silicate phase, the silicate phase comprising a) yttrium and b) at least one other species selected from the group consisting of ytterbium and lutetium, wherein the material undergoes no solid state phase transformation reaction in the temperature range from about 1100 degrees Celsius to about 1275 degrees Celsius; and a topcoat disposed over the coating, wherein the topcoat comprises at least one selected from the group consisting of an aluminate, an aluminosilicate, a silicate (such as a rare earth monosilicate, for example), and zirconia, such as yttria-stabilized zirconia.

### EXAMPLES

### Example-1

Mixed powder batches having a nominal composition in accordance with formula (1), above, where A=Yttrium, D=Lutetium and x=0.1, 0.2, and 0.4 were prepared by mixing appropriate amounts of Y₂Si₂O₇ and Lu₂Si₂O₇ powders (average particle sizes of about 1 um) in an attrition mill containing YSZ media and isopropyl alcohol. The powder mixtures were milled for 8 hours to reduce the particle size further and to ensure intimate mixing. Pressed pellets were fabricated from the dried milled powders by uniaxial pressing of about 2 g of powder in a circular die under 50 MPa of pressure. Similar pellets were also fabricated using attrition milled Y₂Si₂O₇ powder. The as-pressed pellets of mixed powders were confirmed to be a mixture of Y₂Si₂O₇ and Lu₂Si₂O₇ by XRD. The pressed pellets were placed on platinum foil and were subjected to a first heat treatment at 1325° C. for 48 hours and were cooled down to ambient temperature. All samples were identified to be single phase type-C (beta phase) Y₂₍₁₋ₓ₎Lu₂ₓSi₂O₇ structure by x-ray diffraction.

A second heat-treatment was applied to a selected group of specimens with x=0, 0.1, 0.2 and 0.4 for 2 hours at 1550° C. The phase structures of the pellets with x=0, 0.1 and 0.2 were identified as single-phase type-D Y₂₍₁₋ₓ₎Lu₂ₓSi₂O₇, indicating a phase transformation had occurred; however, the material with x=0.4 was identified as single-phase type-C Y₂₍₁₋ₓ₎Lu₂ₓSi₂O₇, suggesting the composition had remained type C during the treatment. A different second heat treatment (24 hours at 1425° C.) was applied to another selected group of specimens with x=0, 0.1, 0.2 and 0.4. The phase structures of the pellets with x=0 and x=0.1 were identified as single phase type-D Y₂₍₁₋ₓ₎Lu₂ₓSi₂O₇, and the materials with x=0.2 and x=0.4 were identified as single-phase type-C Y₂₍₁₋ₓ₎Lu₂ₓSi₂O₇.

Metallographic sections were prepared from selected samples with type-D structure (Y₂Si₂O₇, Y_{1.8}Lu_{0.2}Si₂O₇ and Y_{1.6}Lu_{0.4}Si₂O₇) and type-C structure (Y_{1.6}Lu_{0.4}Si₂O₇ and Y_{1.2}Lu_{0.8}Si₂O₇), and were observed using a scanning electron microscope. All materials showed similar microstructure with a grain size in the range of approximately 2-7 um. All materials with type-D structure showed small transgranular cracks. No such cracks could be observed in the materials with type-C structure, suggesting that the cracks were associated with the transformation from type-C to type-D.

### Example-2

Mixed powder batches having a nominal composition in accordance with formula (1), above, where A=Yttrium, D=Ytterbium and x=0.1, 0.2, 0.3, and 0.4 were prepared by mixing appropriate amounts of Y₂Si₂O₇ and Yb₂Si₂O₇ powders (average particle sizes of about 1 um) in an attrition mill containing YSZ media and isopropyl alcohol. The powder mixtures were milled for 8 hours to reduce the particle size further and to ensure intimate mixing. Pressed pellets were fabricated from the dried milled powders by uniaxial pressing of about 2 g of powder in a circular die under 50 MPa of pressure. Similar pellets were also fabricated using attrition milled Y₂Si₂O₇ powder. The pressed pellets were placed on platinum foil and were submitted to a first heat treatment at 1325° C. for 72 hours and were cooled down to ambient temperature. All samples were identified by x-ray diffraction to be single phase type-C (beta phase) Y₂₍₁₋ₓ₎Yb₂ₓSi₂O₇ structure.

A second heat-treatment was applied to a selected group of specimens with x=0, 0.1, 0.2, 0.3 and 0.4 for 24 hours at 1425° C. All samples with x>0.3 were found to be single-phase type-C Y₂₍₁₋ₓ₎Yb₂ₓSi₂O₇. Specimens with x<0.3 showed a mixture of type-C and type-D phases.

### Example-3

Environmental barrier coating (EBC) samples were prepared on silicon carbide fiber-reinforced silicon carbide ceramic matrix composite substrates by atmospheric plasma spray deposition. Y₂Si₂O₇ and Y_{1.2}Yb_{0.8}Si₂O₇ powders were used to deposit rare-earth silicate EBC layers. The thicknesses of Y₂Si₂O₇ and Y_{1.2}Yb_{0.8}Si₂O₇ layers were in the range 50 um-0.5 mm. The coatings were submitted to cyclic steam (2 hour cycle) tests at 1315° C. for 500 hours, 1000 hours, and 2000 hours in a 90% H₂O+10% O₂ atmosphere. After each 500 hour test interval, specimens were removed from each coating sample and were examined using x-ray diffraction and scanning electron microscope. The as-fabricated Y₂Si₂O₇ layers were found to be a mixture of type-C and type-D crystal structures, and the as-fabricated Y_{1.2}Yb_{0.8}Si₂O₇ layers were found to be type-C crystal structure. The Y₂Si₂O₇ coating layers were found to have completely transformed to type-D structure after a 500 hour test, and evidence of cracking was readily identified in the microstructure of these Y₂Si₂O₇ coatings. The grain size of the Y₂Si₂O₇ coating layers was found to be in the range of 20 μm-200 μm. The number and the size of the cracks present in the Y₂Si₂O₇ layer were found to increase with test time between 500 hours and 2000 hours. The coating samples fabricated using Y_{1.2}Yb_{0.8}Si₂O₇ material were found to be type-C structure by XRD under all test conditions, and showed no evidence of the cracking observed in the coatings fabricated using Y₂Si₂O₇.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An article comprising:
a substrate; and
a coating disposed over the substrate, wherein the coating comprises a monoclinic silicate phase, wherein the phase undergoes no solid state phase transformation reaction in the temperature range from about 1100 degrees Celsius to about 1275 degrees Celsius.

2. The article of claim 1, wherein the silicate phase has a composition in accordance with the formula
A₂₍₁₋ₓ₎D₂ₓSi₂O₇,
where x is in the range from about 0.01 to about 0.9;
wherein A has an ionic radius and is at least one element selected from the group consisting of erbium, yttrium, holmium, dysprosium, terbium, and gadolinium; and D is at least one cation having an ionic radius smaller than the ionic radius of A.

3. The article of claim 2, wherein D is at least one element selected from the group consisting of scandium, lutetium, ytterbium, thulium, titanium, and zirconium.

4. The article of claim 2, wherein A comprises yttrium.

5. The article of claim 4, wherein D comprises ytterbium.

6. The article of claim 5, wherein x is in the range from about 0.05 to about 0.5.

7. The article of claim 5, wherein x is in the range from about 0.2 to about 0.4.

8. The article of claim 4, wherein D comprises scandium.

9. The article of claim 8, wherein x is in a range from about 0.05 to about 0.2.

10. The article of claim 4, wherein D comprises lutetium.

11. The article of claim 8, wherein x is in a range from about 0.05 to about 0.35.

12. The article of claim 1, wherein the substrate comprises silicon.

13. The article of claim 12, wherein the substrate comprises a silicon-bearing ceramic material.

14. The article of claim 1, further comprising a bondcoat disposed between the substrate and the coating, the bondcoat comprising silicon.

15. The article of claim 1, further comprising a topcoat disposed over the coating.

16. The article of claim 15, wherein the topcoat comprises at least one selected from the group consisting of an aluminate, an aluminosilicate, a silicate, and zirconia.

17. The article of claim 1, wherein the article comprises a component of a gas turbine assembly.

18. The article of claim 17, wherein the component is a vane, a blade, a shroud, or a combustor component.

19. The article of claim 1, wherein the temperature range is from about 1100 degrees Celsius to about 1300 degrees Celsius.

20. The article of claim 1, wherein the temperature range is from about 1100 degrees Celsius to about 1550 degrees Celsius.

21. An article comprising:
a substrate comprising a silicon-bearing ceramic material;
a bondcoat comprising silicon disposed over the substrate;
a coating disposed over the bondcoat, wherein the coating comprises a monoclinic silicate phase, the silicate phase comprising a) yttrium and b) at least one other species selected from the group consisting of ytterbium and lutetium, wherein the material undergoes no solid state phase transformation reaction in the temperature range from about 1100 degrees Celsius to about 1275 degrees Celsius; and
a topcoat disposed over the coating, wherein the topcoat comprises at least one selected from the group consisting of an aluminate, an aluminosilicate, a silicate, and zirconia.
